(19) United States
(12) Patent Application Publication
(10) Pub. No.: US 2021/0012361 A1
(43) Pub. Date: Jan. 14, 2021

(54) REQUEST INFORMATION GROUP OPTIMIZATION METHOD

(71) Applicant: Hitachi-LG Data Storage, Inc., Tokyo (JP)

(72) Inventors: Keiichi MITANI, Tokyo (JP); Akinobu WATANABE, Tokyo (JP); Atsushi NEO, Tokyo (JP)

(21) Appl. No.: 16/858,789

(22) Filed: Apr. 27, 2020

(30) Foreign Application Priority Data
Jul. 12, 2019 (JP) 2019-130389

(51) Int. Cl. G06Q 30/02

(52) U.S. Cl. CPC G06Q 30/0204; G06Q 30/0201

(57) ABSTRACT

A request information group optimization method for optimizing a request information group includes: inputting external information; analyzing the external information according to analysis conditions; estimating a customer information group based on an analysis result; optimizing the request information group by rearranging the request information group until the estimated customer information group satisfies optimization conditions; and linking a product ID in the request information group to existing information of the product ID that is obligated to be described and estimating information necessary for optimization using the existing information.

### CROSS-REFERENCE TO RELATED APPLICATION

The present application claims priority from Japanese application JP2019-130389, filed on Jul. 12, 2019, the contents of which is hereby incorporated by reference into this application.

### BACKGROUND OF THE INVENTION

### 1. Field of the Invention

The present invention relates to a technique for optimizing a product sales form or a store sales form.

### 2. Description of the Related Art

In recent years, attempts have been made to improve services by accumulating and analyzing the customer's moving route, product purchase behavior in a store, or the like and predicting customer preferences or trends based on the results. In addition, a demonstration experiment on unmanned store technology has been performed, and sufficient information can be acquired by a sensor installed in the store.

JP 2016-4353 A and JP 2005-31963 A are related arts in this technical field. JP 2016-4353 A is a method of estimating the customer's purchase behavior in a store or between stores, and discloses that a computer system executes: (a) Step of acquiring product information on a product that a target customer purchased or tried to purchase in the store or between the stores and information on the layout of the store and information on the shelf allocation of the store; (b) Step of reading at least one route information of (b-1) information on a past route in which one or more customers have moved in the store or between the stores or information on a past route estimated that one or more customers have moved in the store or between the stores and (b-2) information on a past route in which the target customer has moved in the store or between the stores or information on a past route estimated that the target customer has moved in the store or between the stores; and (c) Step of estimating the movements of the target customer in the store or between the stores based on each piece of information acquired in the step (a) according to the tendency obtained from the route information read in the step (b).

In addition, JP 2005-31963 A discloses that a customer ID and a product ID are periodically read from a customer wireless tag 11 moving together with a customer and a product wireless tag 12 attached to a product by a plurality of wireless tag readers 13 installed in a store, tag information including the customer ID, the product ID, a reader ID, and time information is generated and collected, a moving trajectory analysis server 15 creates movements data for each customer and each product in the store and creates information between products indicating a combination of products that are likely to be purchased simultaneously by the same customer, and a layout evaluation and proposal server 16 evaluates the product layout in the store based on the information between products and the arrangement of products in the store and proposes an effective product layout.

Using the related arts of JP 2016-4353 A and JP 2005-31963 A, management of a product display location, acquisition of customer's moving route, purchased products, and the like, estimation of customer behavior in a store or between stores using accumulated and analyzed information, or in-store layout evaluation and proposal become possible.

However, the product information acquired by the related arts is unique information, and estimation of customer behaviors with respect to product information that has been acquired, accumulated, and analyzed in the past is possible. However, there is a problem that estimation for new products that have not been acquired in the past is not possible.

### SUMMARY OF THE INVENTION

In view of the above background art and problems, according to an aspect of the invention, a request information group optimization method for optimizing a request information group includes: inputting external information; analyzing the external information according to analysis conditions; estimating a customer information group based on an analysis result; optimizing the request information group by rearranging the request information group until the estimated customer information group satisfies optimization conditions; and linking a product ID in the request information group to existing information of the product ID that is obligated to be described and estimating information necessary for optimization using the existing information.

According to the invention, it is possible to provide a request information group optimization method capable of responding quickly to a shortened product life cycle.

### BRIEF DESCRIPTION OF THE DRAWINGS

FIG. 1 is a configuration diagram of a product display optimization system according to a first embodiment;

FIG. 2 is a processing flowchart of a time stamp information adding unit and an information storage unit according to the first embodiment;

FIG. 3A is a diagram illustrating information of an external information group, an internal information group, a product information group, and a customer information group stored in the information storage unit according to the first embodiment;

FIG. 3B is a diagram describing product element information according to the first embodiment and a process of linking the product element information to a product ID in the information storage unit;

FIG. 4 is a flowchart of a product display optimization unit, a customer movements estimation unit, and a customer movements evaluation unit according to the first embodiment;

FIG. 5 is a configuration diagram of a product ID optimization system according to a second embodiment;

FIG. 6 is a processing flowchart for optimizing a product ID according to the second embodiment;

FIG. 7 is a configuration diagram of a product optimization system according to a third embodiment; and

FIG. 8 is a processing flowchart for optimizing a product ID, a display location, a shape, and a sales form according to the third embodiment.

### DETAILED DESCRIPTION OF THE PREFERRED EMBODIMENTS

Hereinafter, embodiments of the invention will be described with reference to the accompanying diagrams.

### First Embodiment

In the present embodiment, an example will be described in which a request information group to be optimized is a product display location. In addition, the present embodiment can be implemented as a system that analyzes and stores acquired information on the inside and outside of a store, products, and customers and reduces the degree of congestion in the store.

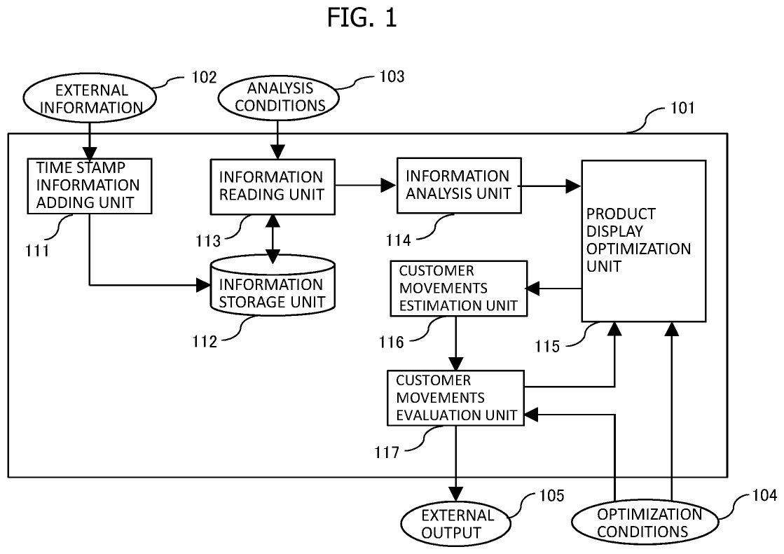

FIG. 1 is a configuration diagram of a product display optimization system according to the present embodiment. In FIG. 1, a product display optimization system 101 includes a time stamp information adding unit 111 for adding time stamp information to external information 102 that is information input from the outside, an information storage unit 112 for storing information, an information reading unit 113 for reading analysis conditions 103 input from the outside, an information analysis unit 114 for performing analysis processing, a product display optimization unit 115 for performing product display optimization processing, a customer movements estimation unit 116 for performing customer movements estimation processing, and a customer movements evaluation unit 117 for evaluating the customer movements.

In addition, the product display optimization system 101 illustrated in FIG. 1 is realized by an apparatus having a processing device (CPU), a storage device (memory), and an input and output interface (I/F), which is a general information processing apparatus as a hardware image. That is, the processing of the time stamp information adding unit 111, the information reading unit 113, the information analysis unit 114, the product display optimization unit 115, the customer movements estimation unit 116, and the customer movements evaluation unit 117 other than the information storage unit 112 of the product display optimization system 101 is executed by the CPU performing software processing of processing programs stored in the storage device. In addition, the information storage unit 112 corresponds to a storage device. In addition, the external information 102, the analysis conditions 103, optimization conditions 104, and an external output 105, which will be described later, are input and output through the input and output I/F.

The external information 102 is input information to the time stamp information adding unit 111 that can be acquired from a sensor, an information terminal, or the like. The external information 102 is external information (referred to as an external information group) for the store, such as weather, season, and the area where the store is located; internal information (referred to as an internal information group) for the store, such as human costs and an in-store layout diagram (a diagram illustrating locations of shelves where products can be placed or the like); information on a product (referred to as a product information group), such as a product ID (type of product), display location, shape, and sales form such as bulk sales; information (referred to as a customer information group) relevant to entry information, a moving route (movements) in the store, or physical information, paid products, and exit information for each customer; or an end code for ending the processing of the product display optimization system 101.

Here, examples of an input method and an input time of the external information 102 will be described. As the external information group, information such as weather periodically observed by the clerk is input to the product display optimization system 101. The internal information group is input to the product display optimization system 101 when the clerk changes the layout in the store. The product information group is input by being read by an information terminal, such as a barcode reader, when the product arrives. As the customer information group, the location of the customer detected at predetermined time intervals by a camera or sensor installed on the ceiling is input to the product display optimization system 101. The end code is input when the clerk ends the product display optimization system 101.

However, the input method and the input time of the external information 102 are not limited to these. For example, the weather may be determined based on an image periodically acquired by a sensor or the like, and may be input to the product display optimization system 101.

The time stamp information adding unit 111 adds the time at which the external information 102 was input and season information determined from the input time, as time stamp information, to the external information 102 and outputs information obtained as a result to the information storage unit 112 described later.

The information storage unit 112 receives and stores the information input from the time stamp information adding unit 111. When storing the information, the storage method is changed depending on the type of information. That is, as for the external information group, weather and season information to which the time stamp information is added is stored. As for the internal information group, in-store layout information to which the time stamp information is added is stored. As for the customer information group, the entry time, the movements from the entry time to the exit time, and paid product information are managed for each customer. For this reason, when customer information to be stored is already present in customer information that is input periodically, the movements information of the corresponding customer is updated. Conversely, when the customer information to be stored is not present, movements information is newly added together with the customer information with the time stamp information as the entry time. In addition, when the user leaves the store and enters the store again, new information is added.

In addition, when the product information input from the time stamp information adding unit 111 is already stored in the information storage unit 112 and the display locations match each other, the product information group is not stored. When the display locations do not match each other even if the product information input from the time stamp information adding unit 111 is already stored in the information storage unit 112, the product information group is stored as new information. In the product information group input from the time stamp information adding unit 111, when product information is not stored in the information storage unit 112, a location close to the display location of a product with the most similar product element is newly added as a display location based on product element information described later. In addition, according to an output instruction for outputting information corresponding to a designated period in the information stored in the information storage unit 112, which is input from the information reading unit 113 to be described later, the information is output to the information reading unit 113 using the time stamp information linked to the information. In addition, when storing the product information, the product ID is linked to product element information described later. The details of the operations of the time stamp information adding unit 111 and the information storage unit 112 will be described later.

The analysis conditions 103 are constraint conditions on the analysis processing input by the system user, and restriction conditions, such as using only information corresponding to a designated period in the information stored in the information storage unit 112 for the analysis, are output to the information reading unit 113 described later.

The information reading unit 113 receives the information of the analysis conditions 103, outputs the restriction conditions to the information storage unit 112, and receives information corresponding to the period designated in the restriction conditions from the information storage unit 112. In addition, the information received from the information storage unit 112 is output to the information analysis unit 114 described later.

The information analysis unit 114 analyzes a time-series causal relationship of the customer information group with respect to the external information group, the internal information group, and the product information group using the information input from the information reading unit 113, calculates information of a correlation between a paid product and each movement, and outputs the correlation information to the product display optimization unit 115 described later. For example, umbrella sales increases on a rainy day. Thus, a target product that a customer desires to purchase differs depending on the external information group such as weather or season. As described above, since the customer moves in the store to purchase the target product, the movements depend on the external information group and the product information group. In addition, since the store side predicts such demands and changes the in-store layout in advance to devise products and product display locations that are effective on rainy days, the movements also depend on the internal information group.

Therefore, it is possible to analyze the movements depending on the product information group by calculating the correlation between each movement and a paid product depending on the external information group and the internal information group from the customer information group, and the result is output to the product display optimization unit 115.

The optimization conditions 104 are constraint conditions on optimization processing input by the system user. The optimization conditions 104 are processing conditions such as “information to be optimized is a product display location”, evaluation criteria required for optimization such as evaluating the passing frequency [times/s] of customers at an arbitrary point in the store per unit time, and determination conditions such as ending optimization when the standard deviation of the passing frequency for the entire area where customers can pass in the in-store layout falls below a predetermined value [times/s] (when the standard deviation becomes uniform for the entire area). The processing conditions are output to the product display optimization unit 115 described below, and the evaluation criteria and the determination conditions are output to the customer movements evaluation unit 117 described later.

First, based on the movements result depending on the product display location that is input from the information analysis unit 114, the product display optimization unit 115 changes the product display location according to the processing conditions input from the optimization conditions 104, and outputs the changed product display location to the customer movements estimation unit 116 described later. For example, at a location where the passing frequency is high in the store, for a product that causes the high passing frequency, the display location of a product that is arranged near a location where the passing frequency is low is output. In the first optimization processing, since the display location of the product is not held, the display location of the product is randomly generated and output. Second, the display location is changed according to the processing conditions input from the optimization conditions 104 based on the evaluation result input from the customer movements evaluation unit 117 described later, and the changed display location is output to the customer movements estimation unit 116.

The customer movements estimation unit 116 estimates the movements of the customer based on the product display location received from the product display optimization unit 115, and outputs the estimation result and the display location to the customer movements evaluation unit 117 described later.

According to the received evaluation criteria, the customer movements evaluation unit 117 evaluates the passing frequency of customers at an arbitrary point in the store per unit time based on the external information input from the customer movements estimation unit 116. If the determination conditions input from the optimization conditions 104 are satisfied, the product display location is output to the external output 105. If the determination conditions input from the optimization conditions 104 are not satisfied, the evaluation result is output to the product display optimization unit 115.

The external output 105 receives the optimized product display location from the customer movements evaluation unit 117.

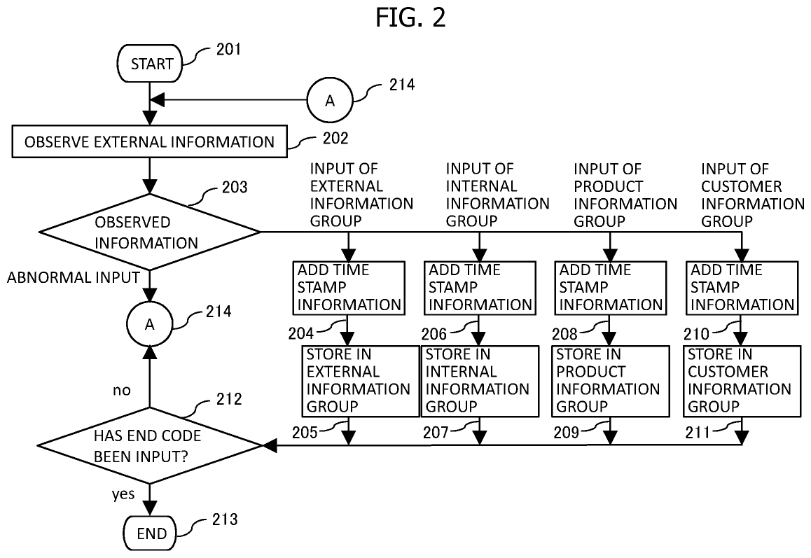

FIG. 2 is a processing flowchart of the time stamp information adding unit 111 and the information storage unit 112 according to the present embodiment. In FIG. 2, the process starts in step 201. First, the external information 102 is observed (step 202), and different operations are performed according to the type (step 203). When there is an abnormal input, such as an empty input, the process returns to immediately before step 202 (step 214). When an external information group is input in step 203, the time stamp information adding unit 111 adds time stamp information to the external information group (step 204), and adds the external information group to the external information group list in the information storage unit 112 (step 205). Similar processing (steps 206 and 207, 208 and 209, and 210 and 211) is performed on the internal information group, the product information group, and the customer information group. Then, it is checked whether or not an end code has been input (step 212). If the end code is input, the process ends (step 213). If the end code is not input, the process returns to immediately before step 202 (step 214).

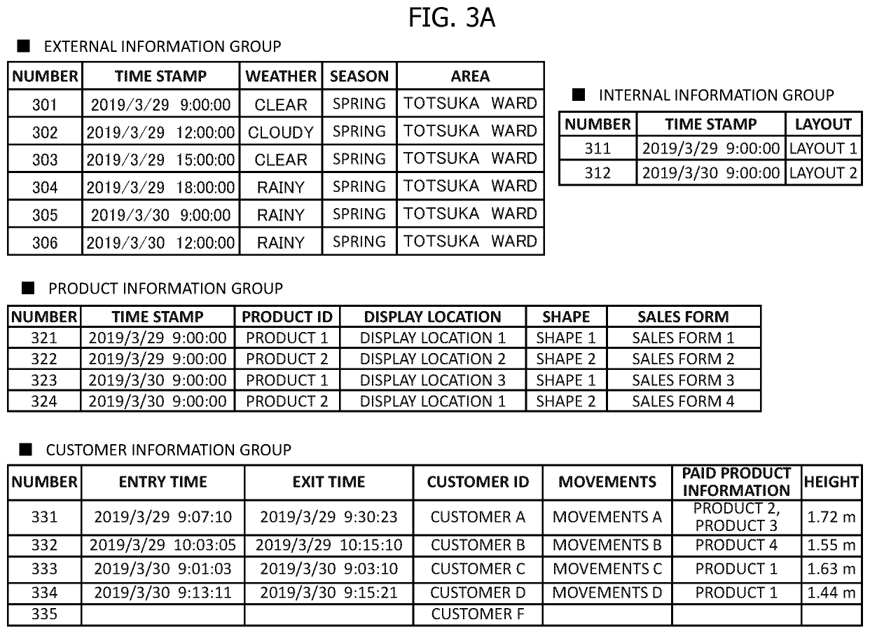

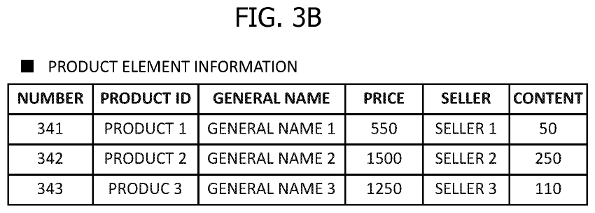

FIG. 3A is a diagram illustrating information of an external information group, an internal information group, a product information group, and a customer information group stored in the information storage unit 112 according to the present embodiment. In FIG. 3A, for example, in a store that is open from 9:00 to 18:00, a situation when information of external information groups 301 to 306, internal information groups 311 and 312, product information groups 321 to 324, and customer information groups 331 to 335 is stored is as follows. The weather and season were acquired every three hours (301 to 306). At 9:00 am on March 29, the in-store layout was 311, the products are at the display locations of 321 and 322, and the customer's behavior was 331 and 332. Since it rained (304) when the store was closed, the layout of the store for the next day was changed to 312 and the products were displayed at 323 and 324. At this time, the customer's behavior was 333 and 334. In addition, 335 is customer information in which payment has not been completed.

FIG. 3B is a diagram describing product element information according to the present embodiment and a process of linking the product element information to a product ID in the information storage unit 112. In FIG. 3B, the product element information is a general name, a price, a seller, a content, and the like, which are content information that is obligated to be described in the content of the product information. Here, the general name is a generic name of a product specified by the standard. For example, in a customer who intends to purchase a watch (general name), the movements of the customer who desires a particular brand (seller) depend on the seller, or the movements of the customer who desires a cheap product depend on the price, or the movements of the customer who desires a product with a large content depend on the content. In a customer who intends to purchase at a certain brand (seller) store, the movements of the customer, such as purchasing a sweater, a muffler, or a purse (general name) that the customer desires, depend on the general name. For this reason, by calculating the external information group and the internal information group and the movements for each product from the product element information, it is possible to analyze the movements depending on the display location of the product. That is, by using the product element information as product information instead of unique information, it is possible to analyze movements even for a new product that has not been acquired in the past.

In the process of linking the product element information with the product ID, for example, when three product information items are read by a barcode reader, the general name and the price and information of the seller and the content are obtained for the three product IDs, and the pieces of product element information, such as product element information 341 to 343, are linked to the existing product IDs according to the type.

In addition, in the present embodiment, the general name and the price and the information of the seller and the content are linked to the product ID, so that a product display location having the most similar element is added as product information when a product not stored in the information storage unit 112 is stored. However, the invention is not limited to the general name and the price and the information of the seller and the content, and there is no particular limitation within the range of the existing information that is obligated to be described.

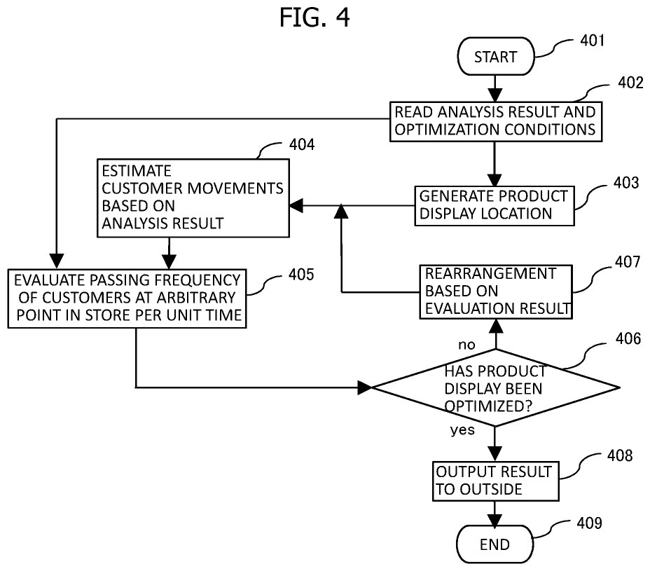

Next, the processing of the product display optimization unit 115, the customer movements estimation unit 116, and the customer movements evaluation unit 117 will be described with reference to FIG. 4. In FIG. 4, in step 401, the product display optimization system 101 starts processing for optimizing a product display location. Then, in step 402, the analysis result output from the information analysis unit 114 and the optimization conditions 104 are read. The product display optimization unit 115 randomly generates a product display location according to the optimization conditions 104, and outputs the product display location to the customer movements estimation unit 116 (step 403). Then, the customer movements estimation unit 116 estimates customer movements in the store from the product display location received from the product display optimization unit 115, and outputs external information reflecting the estimation result to the customer movements evaluation unit 117 (step 404). For example, it is estimated how many customers walk in the store for the product display location. Based on the evaluation criteria, the customer movements evaluation unit 117 evaluates the passing frequency of customers at an arbitrary point in the store per unit time from the movements estimation result received from the customer movements estimation unit 116, and outputs the evaluation result to the product display optimization unit 115 (step 405).

Then, based on the determination conditions, it is determined whether or not the evaluation result shows that the standard deviation of the passing frequency for the entire area where customers can pass in the in-store layout falls below a predetermined value (step 406). If it is determined that the product display location is not optimized in step 406, the customer movements evaluation unit 117 outputs the evaluation result to the product display optimization unit 115, and the product display optimization unit 115 outputs a display location, which is obtained by rearranging the product display location according to the optimization conditions 104 based on the evaluation result, to the customer movements estimation unit 116 (step 407). For example, the location of a product near the area where the standard deviation of the passing frequency is large is adjusted again. If it is determined that the product display location has been optimized, the optimized product display location is output to the external output 105 (step 408), and the process ends (step 409).

A specific example will be described. For example, for the movements of a customer on a rainy day in a convenience store where umbrellas are placed near the entrance, it is likely that the customer purchases only an umbrella and walks to the cash register. The causal relationship at this time is that it rains (external information group) and the space is created at the entrance of the store (internal information group) to place umbrellas and as a result, the ratio of the movements (customer information group) from the umbrella display location (product information group) to the cash register is high. At this time, there is a difference in the passing frequency of one or more customers at an arbitrary point in the store per unit time. Therefore, in order to draw attention as much as possible to products other than the umbrella, an in-store layout that reduces the standard deviation of the passing frequency may be proposed. However, it is not considered significant to remove the space provided at the entrance and place the umbrellas far from the entrance. That is, under the restriction conditions in which information to be used is a rainy day, rain, an in-store layout on the rainy day, and customer movements at the umbrella location may be analyzed, and the processing conditions may be set to optimization of the product display location for a product ID other than the umbrella and the customer movements may be estimated and evaluated based on the analysis result to perform optimization.

Another example will be described. When the winter season comes, many new winter clothes begin to be placed at the storefront in each clothing store every year, but in the early stage, many customers go to the next store while looking at the clothes lined at the storefront. In addition, many stores devise to keep their customers from being tired by changing the arrangement every season. The causal relationship at this time is that the winter comes (external information group) and the layout (internal information group) is changed to place new winter clothes at the storefront and winter clothes are placed at the storefront and as a result, the ratio of the movements (customer information group) from the display location of the new winter clothes (product information group) to the inside of the store or the cash register is low. At this time, there is a difference in the passing frequency of one or more customers at an arbitrary point in the store per unit time. Therefore, in order to draw attention as much as possible to products other than the new winter clothes, a product display that reduces the standard deviation of the passing frequency may be proposed. In addition, not only are new works added every year, but also clothes are seasonal. For this reason, the life cycle of displayed clothes is considered to be about three months. That is, if the display is changed after the display is determined once, the cost and the loss increase. Therefore, under the restriction conditions in which information to be used is the early winter, the early winter, an in-store layout, and customer movements at the location of new clothes may be analyzed, and the processing conditions in the optimization conditions may be set to optimization of the product display location for product IDs including the new clothes and the customer movements may be estimated and evaluated based on the analysis result to perform optimization. At this time, the product element information regarding the new clothes is the brand name, weight, price, color, and the like, and has information common to all clothes. Therefore, since comparison is possible, optimization processing can be performed immediately. As a result, it is possible to reduce the cost and the loss described earlier.

As described above, according to the present embodiment, by handling a series expression based on a combination of existing information that is obligated to be described as an identifier for identifying a product, it is possible to estimate customer behaviors universally even for product information that has not been analyzed in the past. As a result, it is possible to respond quickly to a shortened product life cycle.

In addition, by increasing the complexity of information to be handled to increase the amount of information, customer information can be estimated more flexibly. In addition, information to be evaluated and proposed is not limited to the in-store layout, and information that can lead to customers' visit to the store, including a store sales form or a product sales form considering employee locations and the like, can be handled. By optimizing the in-store layout, the store sales form, the product sales form, and the like, it is possible to reduce the number of man-hours for layout determination, improve customer satisfaction, and discover problems that have not been raised before. That is, since it is possible to flexibly estimate the customer's moving route in a store using highly complex information, it can be expected that an optimal product display without dead space can be obtained with high accuracy. In addition, using information accumulated and analyzed in a store in a certain area, it is possible to perform estimation processing for a store in a different area. This is useful when analyzing differences in sales factors among other stores in the same industry, such as convenience stores and clothing stores. In addition, it is also possible to propose a method of performing analysis and estimation in consideration of information other than customers or the influence of the environment other than stores or the like.

### Second Embodiment

In the present embodiment, an example will be described in which a request information group to be optimized is a product ID.

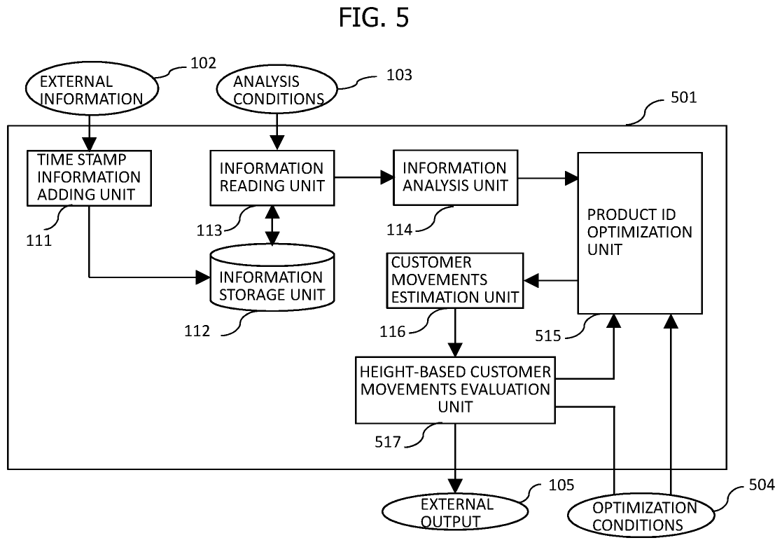

FIG. 5 is a configuration diagram of a product ID optimization system according to the present embodiment. In FIG. 5, the same functions as in FIG. 1 are denoted by the same reference numerals, and the description thereof will be omitted. FIG. 5 is different from FIG. 1 in that a product ID optimization unit 515 for optimizing a product ID (type of product), a height-based customer movements evaluation unit 517 for evaluating a passing frequency at an arbitrary point per unit time for each height, and specific optimization conditions 504 are provided instead of the product display optimization unit 115, the customer movements evaluation unit 117, and the optimization conditions 104, respectively. That is, the optimization conditions 504 are processing conditions for optimizing the product ID, evaluation criteria for evaluating a passing frequency at an arbitrary point per unit time for each height of a customer moving in the store, and determination conditions for ending optimization when the ratio between the number of customers having a height of about 1.0 to 1.4 m and the number of customers having a height of more than 1.4 m becomes about 50%.

In a store that sells products for elementary school students, children and their parents often come to the store, and the parents often purchase products that the children like. However, the person who runs the store is an adult, and it is not easy to think of products for customers of different generations. Therefore, in the present embodiment, as optimization of a product ID for which an elementary school student is a customer with a height of about 1.0 to 1.4 m, a parent has a height larger than 1.4 m, half of the customers moving in the store are parents, and all parents are accompanied by children, the customer movements are estimated and evaluated.

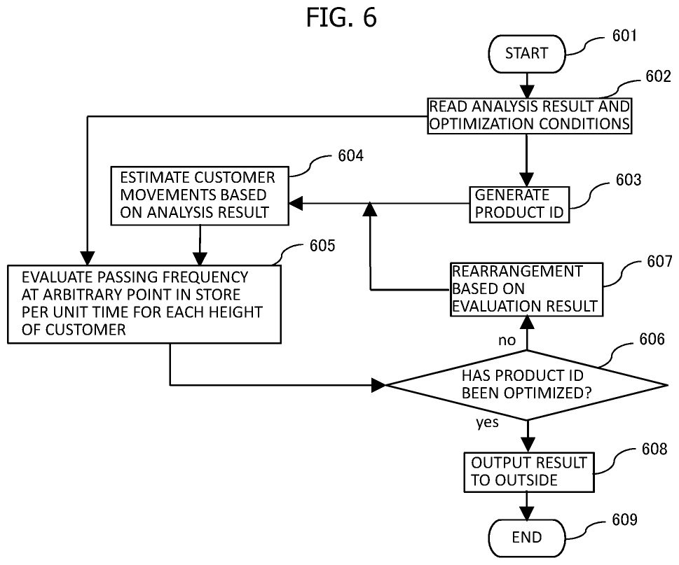

FIG. 6 is a processing flowchart for optimizing a product ID according to the present embodiment. In FIG. 6, steps 601 and 602 are the same as those in FIG. 4 of the first embodiment. A product ID is randomly generated in step 603, and how many customers walk in the store is estimated for each product ID (step 604). Then, in step 605, the passing frequency at an arbitrary point per unit time is evaluated for each height of the customer, and the evaluation result is input to the product ID optimization unit 515. According to the determination criteria, the ratio between elementary school students and their parents are calculated and determined (step 606). If it is determined that the ratio has not been optimized, the product IDs are rearranged (step 607). If it is determined that the ratio has been optimized, the product IDs are output to the outside (step 608) to end the process (step 609). When rearranging the product IDs, for example, when the ratio between elementary school children and their parents is the number of elementary school students:the number of parents=30%:70%, product IDs in an area where the passing frequency at an arbitrary point per unit time for the parents varies greatly is changed.

As described above, according to the present embodiment, it is possible to obtain the result of what kind of product has a large number of customers with children. This processing is enabled by expressing the product ID with the product element information.

### Third Embodiment

In the present embodiment, an example will be described in which a request information group to be optimized is a product ID, a display location, a shape, and a sales form.

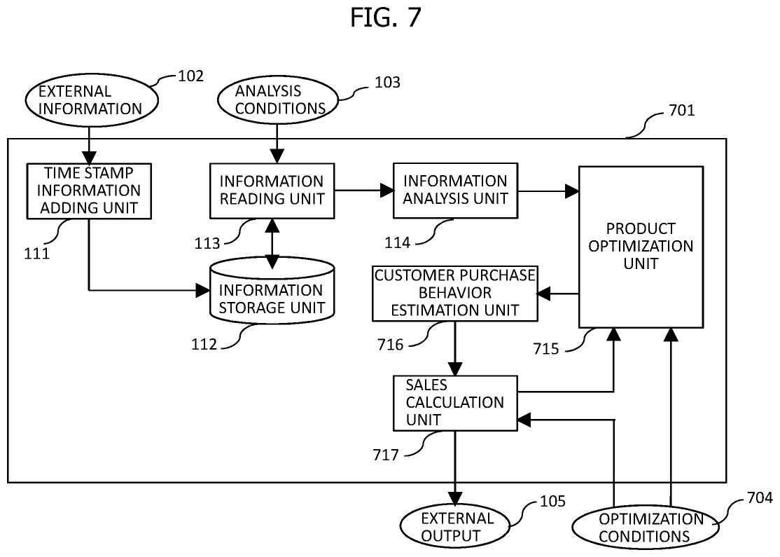

FIG. 7 is a configuration diagram of a product optimization system according to the present embodiment. In FIG. 7, the same functions as in FIG. 1 are denoted by the same reference numerals, and the description thereof will be omitted. FIG. 7 is different from FIG. 1 in that a product optimization unit 715 for optimizing an ID, a display location, a shape, and a sales form of a product is provided instead of the product display optimization unit 115, a customer purchase behavior estimation unit 716 for estimating a customer's product purchase behavior is provided instead of the customer movements estimation unit 116, a sales calculation unit 717 for calculating sales from the estimated customer's product purchase behavior is provided, and optimization conditions 704 is provided instead of the optimization conditions 104. That is, the optimization conditions 704 are processing conditions for optimizing the ID, the display location, the shape, and the sales form of a product, evaluation criteria for evaluating the sales of each product, and determination conditions for ending optimization when the sales exceed 120% of the last month average.

Beverages displayed in a vending machine differ depending on the installation location, and the vending machine owner performs product adjustment according to the area or the season. Types of customers who use vending machines include a customer who uses a specific beverage, such as coffee or water, and a customer who does not particularly specify the type of the beverage. However, the owner is not particularly interested in either of the two types of customers described above, but is likely to be interested in simple sales. Therefore, the external information group is season and area, the internal information group is a circular area within 5 m around the vending machine (layout around the vending machine), the product information group is the display location of hot or cold (sales form) cans or plastic bottles (shape), the customer information group is a paid product, and the restriction conditions are last month.

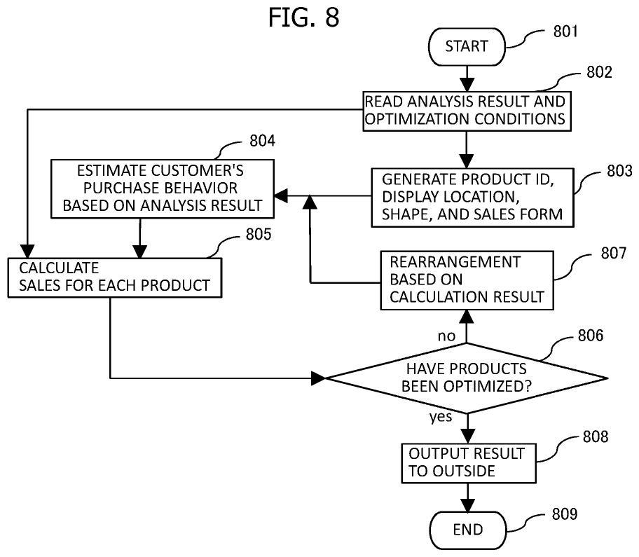

FIG. 8 is a processing flowchart for optimizing a product ID, a display location, a shape, and a sales form according to the present embodiment. In FIG. 8, steps 801 and 802 are the same as those in FIG. 4 of the first embodiment. A product ID, a display location, a shape, and a sales form are randomly generated in step 803, and it is estimated which product each customer will purchase for the product ID, the display location, the shape, and the sales form (step 804). In step 805, sales for each product are calculated, and the calculation result is input to the product optimization unit 715. One month sales are determined according to the determination criteria (step 806). If it is determined that the sales have not been optimized, the product ID, the display location, the shape, and the sales form are rearranged (step 807). If it is determined that the sales have been optimized, the product ID, the display location, the shape, and the sales form are output to the outside (step 808), and the process ends (step 809). When rearranging the product ID, the display location, the shape, and the sales form, for example, the product ID, the display location, the shape, and the sales form with less sales are changed.

As described above, according to the present embodiment, it is possible to arrange beverages so that the sales are 120% of the last month.

While the embodiments have been described above, the invention is not limited to the above-described embodiments, and includes various modifications. For example, the above embodiments have been described in detail for easy understanding of the invention, but the invention is not necessarily limited to having all the components described above. In addition, some of the components in one embodiment can be replaced with the components in another embodiment, and the components in another embodiment can be added to the components in one embodiment. In addition, for some of the components in each embodiment, addition, removal, and replacement of other components are possible.

What is claimed is:

1. A request information group optimization method for optimizing a request information group, comprising:
inputting external information;
analyzing the external information according to analysis conditions;
estimating a customer information group based on an analysis result;
optimizing the request information group by rearranging the request information group until the estimated customer information group satisfies optimization conditions; and
linking a product ID in the request information group to existing information of the product ID that is obligated to be described and estimating information necessary for optimization using the existing information.

2. The request information group optimization method according to claim 1,
wherein the external information includes an external information group having external information on a store, an internal information group having internal information on a store, a product information group having information on a product, and a customer information group having information on a customer.

3. The request information group optimization method according to claim 2, further comprising:
an initial state generation step for performing automatic and random initial arrangement of the request information group to be optimized in the external information;
a customer information estimation step for estimating a customer information group for external information after reflection, in which the initial arrangement in the initial state generation step is reflected, based on a feature information group obtained by analyzing the external information;
a customer information group evaluation step for evaluating a customer information group after estimation in which the customer information group estimated in the customer information estimation step is reflected; and
an optimization step in which it is determined whether or not a request information group in the external information after reflection has been optimized based on an evaluation result evaluated in the customer information group evaluation step and in which the request information group is output to an outside and processing ends if it is determined that the request information group in the external information after reflection has been optimized and the request information group is rearranged based on the evaluation result and the customer information estimation step is performed if it is determined that the request information group in the external information after reflection has not been optimized.

4. The request information group optimization method according to claim 3,
wherein the request information group is a product display location, and
the customer information group is movements of a customer.

5. The request information group optimization method according to claim 3,
wherein the request information group is a product ID, and
the customer information group is movements of a customer.

6. The request information group optimization method according to claim 3,
wherein the request information group is an ID, a display location, a shape, and a sales form of a product, and
the customer information group is a purchasing behavior of a customer.
